(19) United States
(12) Patent Application Publication
(10) Pub. No.: US 2024/0380742 A1
(43) Pub. Date: Nov. 14, 2024

(54) INFORMATION PROTECTION MRTHOD AND DEVICE

(71) Applicant: GUANGDONG OPPO MOBILE TELECOMMUNICATIONS CORP., LTD., Dongguan (CN)

(72) Inventors: Yang XU, Dongguan (CN); Jingran CHEN, Dongguan (CN); Boren GUO, Dongguan (CN)

(21) Appl. No.: 18/779,486

(22) Filed: Jul. 22, 2024

Related U.S. Application Data
(63) Continuation of application No. PCT/CN2022/074508, filed on Jan. 28, 2022.

(51) Int. Cl. H04L 9/40; H04L 9/08

(52) U.S. Cl. CPC H04L 63/08; H04L 9/0861

(57) ABSTRACT

An information protection method includes: performing, by a first device, security protection on first information by using a first key; and sending, by the first device, the first information with security protection to a second device, for use by the second device to send the first information with security protection to a third device by the second device.

### CROSS-REFERENCE TO RELATED APPLICATION

This application is a Continuation Application of PCT/CN2022/074508 filed on Jan. 28, 2022, which is incorporated herein by reference in its entirety.

### TECHNICAL FIELD

The present application relates to the field of communications, and in particular, to an information protection method and a device.

### BACKGROUND

Information security is an important issue in the field of communications. In a case that information is forwarded from a sending terminal to a receiving terminal via other devices, how to ensure security of information transmission, for example, how the receiving terminal determines that the information is truly sent by the sending terminal, is an issue that needs to be considered.

### SUMMARY

Embodiments of the present application provide information protection methods and devices.

The embodiments of the present application provide an information protection method, the method including:
performing, by a first device, security protection on first information by using a first key; and
sending, by the first device, the first information with the security protection to a second device, for use by the second device to send the first information with the security protection to a third device.

The embodiments of the present application provide an information protection method, the method including:
receiving, by a third device, first information with the security protection from a second device, the first information with the security protection being received from the first device and forwarded by the second device; and
performing, by the third device, integrity verification and/or decryption on the first information with the security protection using a first key.

The embodiments of the present application provide an information protection method, the method including:
receiving, by a second device, first information with the security protection from a first device; and
sending, by the second device, the first information with the security protection to a third device.

The embodiments of the present application provide an information protection method, the method including:
sending, by a fourth device, an authentication request message to a terminal device, the authentication request message indicating the terminal device to generate a first key, and the first key being used to perform security protection on first information transmitted between the terminal device and a network device via a second device.

The embodiments of the present application provide an information protection method, the method including:
receiving, by a fifth device, an authentication request message; and
sending, by the fifth device, an authentication request response message, the authentication request response message carrying a first indication, and the first indication being used to indicate to generate a first key.

The embodiments of the present application provide a communication device, the communication device including:
a protection unit, configured to perform security protection on first information by using a first key; and
a first transceiver unit, configured to send the first information with the security protection to a second device, for use by the second device to send the first information with the security protection to a third device by the second device.

The embodiments of the present application provide a communication device, the communication device including:
a second transceiver unit, configured to receive first information with the security protection from a second device, the first information with the security protection being received from the first device and forwarded by the second device; and
a verification unit, configured to perform integrity verification and/or decryption on the first information with the security protection using a first key.

The embodiments of the present application provide a communication device, the communication device including:
a third transceiver unit, configured to: receive first information with the security protection from a first device; and send the first information with the security protection to a third device.

The embodiments of the present application provide a communication device, including:
a fourth transceiver unit, configured to send an authentication request message to a terminal device, the authentication request message indicating the terminal device to generate a first key, and the first key being used to perform security protection on first information transmitted between the terminal device and a network device via a second device.

The embodiments of the present application provide a communication device, including:
a fifth transceiver unit, configured to: receive an authentication request message; and send an authentication request response message, the authentication request response message carrying a first indication, and the first indication being used to indicate to generate a first key.

The embodiments of the present application provide a communication device, including a processor and a memory. The memory is configured to store a computer program, and the processor is configured to invoke and execute the computer program stored in the memory to cause the communication device to perform the above-mentioned information protection methods.

The embodiment of the present application provides a chip for implementing the above-mentioned information protection methods.

In some embodiments, the chip includes: a processor, configured to invoke and execute a computer program from a memory to causes a device equipped with the chip to perform the above-mentioned information protection methods.

The embodiments of the present application provide a non-transitory computer-readable storage medium, configured to store a computer program. The computer program, when executed by a device, causes the device to perform the above-mentioned information protection methods.

The embodiments of the present application provide a computer program product including computer program instructions that, causes a computer to perform the above-mentioned information protection methods.

The embodiments of the present application provide a computer program that, when executed on a computer, causes the computer to perform the above-mentioned information protection methods.

### BRIEF DESCRIPTION OF THE DRAWINGS

FIG. 1 is a first schematic diagram showing an application scenario, in accordance with embodiments of the present application.

FIG. 2 is a second schematic diagram showing an application scenario, in accordance with embodiments of the present application.

FIG. 3 is a schematic diagram showing an overall framework and information interaction, in accordance with an embodiment of the present application.

FIG. 4 is a schematic flowchart showing an information protection method 400, in accordance with an embodiment of the present application.

FIG. 5 is a schematic flowchart showing a derivation process of a first key in an information protection method, in accordance with an embodiment of the present application.

FIG. 6A is a schematic diagram showing a first method for deriving a verification key in an information protection method, in accordance with an embodiment of the present application.

FIG. 6B is a schematic diagram showing a second method for deriving a verification key in an information protection method, in accordance with an embodiment of the present application.

FIG. 6C is a schematic diagram showing a third method for deriving a verification key in an information protection method, in accordance with an embodiment of the present application.

FIG. 6D is a schematic diagram showing a fourth method for deriving a verification key in an information protection method, in accordance with an embodiment of the present application.

FIG. 7A is a schematic flowchart showing performing security protection on first information and transmitting the first information in an information protection method, in accordance with an embodiment of the present application.

FIG. 7B is a schematic flowchart showing performing security protection on first information and transmitting the first information in an information protection method, in accordance with another embodiment of the present application.

FIG. 8 is a schematic flowchart showing an information protection method 800, in accordance with an embodiment of the present application.

FIG. 9 is a schematic flowchart showing an information protection method 900, in accordance with an embodiment of the present application.

FIG. 10 is a schematic flowchart showing an information protection method 1000, in accordance with an embodiment of the present application.

FIG. 11 is a schematic flowchart showing an information protection method 1100, in accordance with an embodiment of the present application.

FIG. 12 is a schematic block diagram showing a communication device 1200, in accordance with an embodiment of the present application.

FIG. 13 is a schematic block diagram showing a communication device 1300, in accordance with an embodiment of the present application.

FIG. 14 is a schematic block diagram showing a communication device 1400, in accordance with an embodiment of the present application.

FIG. 15 is a schematic block diagram showing a communication device 1500, in accordance with an embodiment of the present application.

FIG. 16 is a schematic block diagram showing a communication device 1600, in accordance with an embodiment of the present application.

FIG. 17 is a schematic block diagram showing a communication device 1700, in accordance with an embodiment of the present application; and

FIG. 18 is a schematic block diagram showing a communication device 1800, in accordance with an embodiment of the present application.

FIG. 19 is a schematic block diagram showing a communication device 1900, in accordance with an embodiment of the present application.

FIG. 20 is a schematic block diagram showing a communication device 2000, in accordance with embodiments of the present application.

FIG. 21 is a schematic block diagram showing a chip 2100, in accordance with embodiments of the present application.

### DETAILED DESCRIPTION

Technical solutions in the embodiments of the present application will be described below with reference to the accompanying drawings in the embodiments of the present application.

The technical solutions in the embodiments of the present application may be applied to various communication systems, such as: a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of NR system, an LTE-based access to unlicensed spectrum (LTE-U) system, an NR-based access to unlicensed spectrum (NR-U) system, a non-terrestrial Networks (NTN) system, a universal mobile telecommunication system (UMTS), wireless local area networks (WLAN), wireless fidelity (Wi-Fi), a 5th-generation (5G) system, and other communication systems.

Generally speaking, traditional communication systems support a limited number of connections that are also easy to implement. However, with development of communication technologies, mobile communication systems will not only support traditional communications, but will further support, for example, device to device (D2D) communication, machine to machine (M2M) communication, machine type communication (MTC), vehicle to vehicle (V2V) communication, vehicle to everything (V2X) communication, or the like. The embodiments of the present application may also be applied to these communication systems.

In a possible implementation, a communication system in the embodiments of the present application may be applied to a carrier aggregation (CA) scenario, a dual connectivity (DC) scenario, or a standalone (SA) networking scenario.

In a possible implementation, a communication system in the embodiments of the present application may be applied to an unlicensed spectrum, where the unlicensed spectrum may also be considered as a shared spectrum; alternatively, the communication system in the embodiments of the present application may also be applied to a licensed spectrum, where the licensed spectrum may also be considered as an unshared spectrum.

The embodiments of the present application describe various embodiments in conjunction with a network device and a terminal device. The terminal device may also be referred to as a user equipment (UE), an access terminal, a user unit, a user station, a mobile station, a mobile platform, a remote station, a remote terminal, a mobile device, a user terminal, a terminal, a wireless communication device, a user agent, a user device, or the like.

The terminal device may be a station (STAION, ST) in WLAN, and the station may be a cellular phone, a cordless phone, a session initiation protocol (SIP) phone, a wireless local loop (WLL) station, a personal digital assistant (PDA) device, a handheld device with wireless communication functions, a computing device, other processing devices connected to a wireless modem, an in-vehicle device, a wearable device, a terminal device in a next-generation communication system (such as an NR network), a terminal device in a future evolved public land mobile network (PLMN), or the like.

In some embodiments of the present application, the terminal device may be deployed on land, including indoor or outdoor, handheld, wearable, or in-vehicle; the terminal device may also be deployed on water (e.g., on a ship); and the terminal device may also be deployed in the air (e.g., on an airplane, on a balloon, or on a satellite).

In the embodiments of the present application, the terminal device may be a mobile phone, a pad, a computer with a wireless transceiver function, a virtual reality (VR) device, an augmented reality (AR) device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, or the like.

By way of example and not limitation, in the embodiments of the present application, the terminal device may also be a wearable device. The wearable device may also be referred to as a wearable smart device, which is a general term for wearable devices developed by using wearable technology and intelligent design for everyday wear, such as glasses, gloves, a watch, clothing, and shoes. The wearable device is a portable device that is worn directly on a body, or integrated into a user's clothing or accessories. The wearable device is not only a hardware device, but also implements powerful functions through software support as well as data interaction or cloud interaction. Generalized wearable smart devices include full-featured, large-sized devices that may implement full or partial functionality without relying on smart phones, such as a smart watch or smart glasses, and devices that focus on a certain type of application functionality only and need to be used in conjunction with other devices (such as smart phones), such as various smart bracelets, and smart jewelries, for monitoring physical signs.

In embodiments of the present application, the network device may be a device for communicating with a mobile device. The network device may be an access point (AP) in WLAN, a base station (Base Transceiver Station, BTS) in GSM or CDMA, a base station (NodeB, NB) in WCDMA, an evolved base station (Evolutional NodeB, eNB or eNodeB) in LTE, a relay station or access point, an in-vehicle device, a wearable device, a network device (gNB) in an NR network, or a network device in a future evolved PLMN network, a network device in an NTN network, or the like.

By way of example and not limitation, in the embodiments of the present application, the network device may have a mobile characteristic, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may also be a base station set up on land, water or the like.

In embodiments of the present application, a network device may provide services for a cell, and a terminal device may communicate with the network device through transmission resources (e.g., frequency domain resources, or rather spectrum resources) used by the cell. The cell may be a cell corresponding to the network device (e.g., a base station). The cell may belong to a macro base station or a base station corresponding to a small cell. Small cells here may include: a metro cell, a micro cell, a pico cell, a femto cell, etc. These small cells have characteristics of small coverage and low transmission power, and are suitable for providing high-speed data transmission services.

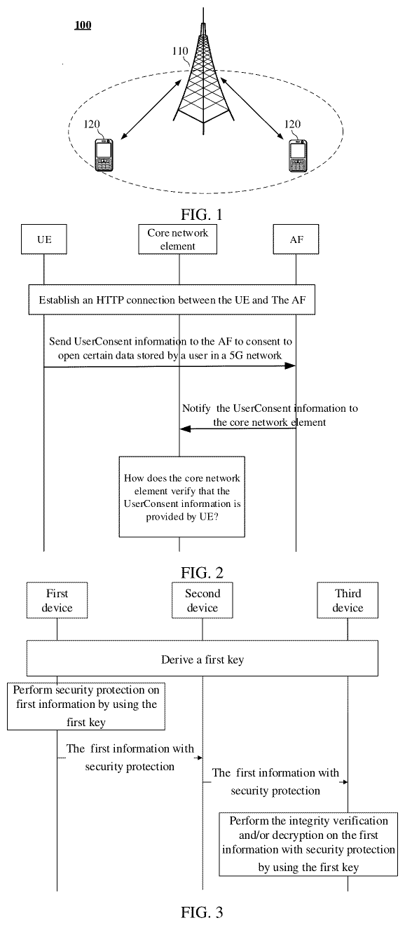

FIG. 1 exemplarily shows a communication system 100. The communication system includes a network device 110 and two terminal devices 120. In a possible implementation, the communication system 100 may include multiple network devices 110, and coverage area of each network device 110 may be provided therein with other number of terminal devices 120, which is not limited in the embodiments of the present application.

In a possible implementation, the communication system 100 may further include other network entities, such as a mobility management entity (MME) and an access and mobility management function (AMF), which is not limited in the embodiments of the present application.

Herein, the network device may include an access network device and a core network device. That is, the wireless communication system further includes multiple core networks for communicating with the access network device. The access network device may be an evolved base station (evolutional node B, which may be referred to as eNB or e-NodeB for short), a macro base station, a micro base station (also called as “small base station”), a pico base station, an access point (AP), a transmission point (TP), a new generation Node B (gNodeB), or the like, in a long-term evolution (LTE) system, a next generation mobile communication system (next radio, NR), or an authorized auxiliary access long-term evolution (LAA-LTE) system.

It should be understood that a device in a network/system having a communication function in the embodiments of the present application may be referred to as a communication device. In an example of the communication system shown in FIG. 1, the communication devices may include the network device and the terminal device, which have the communication function. The network device and the terminal device may be exemplary devices in the embodiments of the present application, and will not be repeated here. The communication devices may further include other devices in the communication system, such as a network controller, a mobile management entity and other network entities, which are not limited in the embodiments of the present application.

It should be understood that terms “system” and “network” are often used interchangeably herein. The term “and/or” herein is only an association relationship to describe associated objects, indicating that there may be three relationships. For example, “A and/or B” may include: A alone, both A and B, and B alone. In addition, the character “/” herein generally indicates that related objects before and after this character are in an “or” relationship.

It should be understood that the “indicate” mentioned in the embodiments of the present application may mean a direct indication or an indirect indication, or represent that there is an association relationship. For example, A indicating B may mean that A directly indicates B, e.g., that B may be obtained through A; or it may mean that A indirectly indicates B, e.g., that A indicates C, and B may be obtained through C; or it may mean that there is an association relationship between A and B.

The term “correspond” described in the embodiments of the present application may mean a relationship of direct or indirect correspondence between two, or a relationship of association between the two, or a relationship of indicating and being indicated, or configuring and being configured, or the like.

To facilitate understanding of the technical solutions in the embodiments of the present application, the technical solutions in the present application are described in detail below through some embodiments. The following related technologies, as optional solutions, may be arbitrarily combined with the technical solutions in the embodiments of the present application, and those combined solutions all belong to protection scope of the embodiments of the present application.

A 5G authentication and key agreement (AKA) process generally occurs during a registration process. A purpose of the 5G AKA is to enable a 5G network to verify that a terminal's user equipment identifier (UE ID), such as a subscription permanent identifier (SUPI) or subscription concealed identifier (SUCI), is validity. At the same time, the terminal may also verify that the 5G network is validity. That is, this process is a bidirectional authentication. After authentication is completed, there will be a key negotiation process whereby integrity protection and encryption keys for a non-access stratum (NAS) and radio are generated, for subsequent data security protection on a user plane and a control plane.

During the AKA process, the terminal and the 5G network side will also derive keys. Since unified data managements (UDMs) of the terminal and the 5G network both store a root key K, these two terminals may use the root key and authentication vector (AV) parameters generated during the AKA process to derive keys at all levels.

Therefore, after the AKA process is completed, the bidirectional authentication is completed between the terminal and the network, and the integrity protection and encryption keys for the NAS and radio are generated, such as Knasint, Knasenc, Kcpenc, Kcpint, Kupenc, or Kupint.

In some scenarios, an application function (AF) will send information received from a terminal to a core network, or sends information received from the core network to the terminal. Then, how the device that receives the information confirms whether the information is authentic and reliable becomes a problem that needs to be solved. Taking an example that the AF sends user authorization or user consent information to a core network element (e.g., policy control function (PCF), or unified data management (user data management, UDM)), the user consent information is used by the core network to carry out related actions, such as enabling a certain service, performing efficient QoS management, monitoring, or opening certain data services. As shown in FIG. 2, after an HTTP connection is established between a UE and an AF, the UE sends user consent information to the AF to consent to open certain data stored by a user in a 5G network. Afterwards, the AF sends the user consent information to the core network element. However, at present, a core network cannot determine whether the user consent information sent by the AF is authentic and reliable. In other words, the core network is impossible to determine whether the user consent information sent by the AF is true intention of the UE or a unilateral decision made by the AF. Therefore, a method is needed to verify information sent by the AF to confirm that the user consent information is true information informed by the UE to the AF. FIG. 2 illustrates an example of transmission information being the user consent information. When other information is transmitted in other application scenarios, such as in a network, the same problem exists as to how the receiving terminal determines whether received information is authentic and reliable.

FIG. 3 is a schematic diagram showing an overall framework and information interaction, in accordance with an embodiment of the present application. As shown in FIG. 3, the embodiments of the present application provide an information protection method, which includes: performing, by a first device, security protection on first information by using a first key, and sending, by a first device, the first information with security protection to a second device; sending, by the second device, the first information with security protection to a third device; and receiving, by the third device, the first information with security protection from the second device, and performing, by the third device, integrity verification and/or decryption on the first information with security protection by using the first key. The first device is an information sending terminal, which may be a terminal device or a network device; the third device is an information receiving terminal, which may also be a terminal device or a network device. The second device may be an AF or a user plane element (user plane function, UPF). The security protection referred to in the embodiments of the present application may include integrity protection and/or encryption. In a case where the integrity protection is performed, the second device may read received first information but cannot tamper with the first information. This is owing to, if the second device tampers with the first information, a receiving terminal is able to identify that the first information has been tampered with when the receiving terminal uses the first key to verify the first information.

In some implementations, the first information may be any information. Taking an example that the first device is a terminal device and the second device is a network device, the first information may be user consent information of the terminal device; and the security protection may include integrity protection and/or encryption. After receiving the first information with security protection, the network device may perform the integrity verification and/or decryption on the first information with security protection by using the first key, thereby verifying whether the first information is information authentically sent by the terminal device.

In the embodiments, an information protection method is provided, the method includes:
performing, by a first device, security protection on first information by using a first key; and
sending, by the first device, the first information with the security protection to a second device, for use by the second device to send the first information with the security protection to a third device.

In some embodiments, the security protection includes integrity protection and/or encryption.

In some embodiments, performing, by the first device, the security protection on the first information by using the first key, includes:
processing, by the first device, the first information by using the first key, to obtain verification information; and
sending, by the first device, the first information with the security protection, includes:
sending, by the first device, the first information and the verification information.

In some embodiments, performing, by the first device, the security protection on the first information by using the first key, includes:
performing, by the first device, encryption on the first information by using the first key, to obtain encrypted first information; and
sending, by the first device, the first information with the security protection, includes:
sending, by the first device, the encrypted first information.

In some embodiments, the method further including:
generating, by the first device, the first key using a second key.

In some embodiments, generating, by the first device, the first key using the second key, includes:
generating, by the first device, the first key using the second key before performing the security protection on first information; and/or
generating, by the first device, the first key using the second key according to a predetermined period.

In some embodiments, the method further including:
sending, by the first device, a key identifier of the first key to the second device.

In some embodiments, the key identifier of the first key is included in the first information; or the key identifier of the first key is independent of the first information.

In some embodiments, the first device includes a terminal device, and the third device includes a network device.

In some embodiments, the first information includes user consent information.

In some embodiments, the method further including:
receiving, by the terminal device, an authentication request message; and
generating, by the terminal device, the first key and/or a second key using parameters carried in the authentication request message, the second key being used to generate the first key.

In some embodiments, generating, by the terminal device, the first key and/or the second key using the parameters carried in the authentication request message, includes:
generating, by the terminal device, a third key using the parameters carried in the authentication request message; and
generating, by the terminal device, the first key and/or the second key using the third key and other parameters and adopting a key derivation function (KDF).

In some embodiments, the third key includes at least one of Kausf, Kakma, Kseaf, or Kamf.

In some embodiments, the other parameters includes at least one of a user equipment (UE) identifier (ID), a random digit (RAND), a counter value, an uplink direction flag, or a downlink direction flag.

In some embodiments, the authentication request message carries a key identifier of the first key.

In some embodiments, the first device includes a network device, and the third device includes a terminal device.

In some embodiments, the method further including:
obtaining, by the network device, the first key from a storage network element.

In the embodiments, obtaining, by the network device, the first key from the storage network element, includes:
obtaining, by the network device, the first key from the storage network element before performing the security protection on the first information; and/or
obtaining, by the network device, the first key from the storage network element according to a predetermined period.

In some embodiments, the method further including:
receiving and storing, by the network device, the first key and a key identifier of the first key; or
receiving and storing, by the network device, a second key and a key identifier of the first key, wherein the second key is used to generate the first key.

In some embodiments, the network device includes a policy control function (PCF) or a network exposure function (NEF).

In the embodiments, an information protection method is provided, the method includes:
receiving, by a third device, first information with the security protection from a second device, the first information with the security protection being received from the first device and forwarded by the second device; and
performing, by the third device, integrity verification and/or decryption on the first information with the security protection using a first key.

In some embodiments, the security protection includes integrity protection and/or encryption.

In some embodiments, receiving, by the third device, the first information with the security protection from the second device, includes:
receiving, by the third device, the first information and verification information from the second device, the verification information being obtained by the first device processing the first information using the first key; and
performing, by the third device, the integrity verification on the first information with the security protection using the first key, includes:
processing, by the third device, the first information using the first key, comparing, by the third device, a processing result with the verification information, and determining, by the third device, integrity of the first information according to a comparison result.

In some embodiments, the method further including:
receiving, by the third device, a key identifier of the first key from the second device.

In some embodiments, the key identifier of the first key is included in the first information; or the key identifier of the first key is independent of the first information.

In some embodiments, the third device includes a network device, and the first device includes a terminal device.

In some embodiments, the first information includes user consent information.

In some embodiments, the method further including at least one of:
determining, by the network device, the first key using a key identifier of the first key;
obtaining, by the network device, the first key from a storage network element using a key identifier of the first key;
determining, by the network device, a second key using a key identifier of the first key, and generating the first key using the second key; or
obtaining, by the network device, a second key from a storage network element using a key identifier of the first key, and generating, by the network device, the first key using the second key.

In some embodiments, the method further including:
receiving and storing, by the network device, the first key and a key identifier of the first key; or
receiving and storing, by the network device, a second key and a key identifier of the first key, wherein the second key is used to generate the first key.

In some embodiments, the third device includes a terminal device, and the first device includes a network device.

In some embodiments, the method further including at least one of:
determining, by the terminal device, the first key using a key identifier of the first key; or
determining, by the terminal device, a second key using a key identifier of the first key, and generating, by the terminal device, the first key using the second key.

In some embodiments, the method further including:
receiving, by the terminal device, an authentication request message; and
generating, by the terminal device, the first key and/or a second key using parameters carried in the authentication request message, the second key being used to generate the first key.

In some embodiments, generating, by the terminal device, the first key and/or the second key using the parameters carried in the authentication request message, includes:
generating, by the terminal device, a third key using the parameters carried in the authentication request message; and
generating, by the terminal device, the first key and/or the second key using the third key and other parameters and adopting a key derivation function (KDF).

In some embodiments, the third key includes at least one of Kausf, Kakma, Kseaf, or Kamf.

In some embodiments, the other parameters include at least one of a user equipment (UE) identifier (ID), a random digit (RAND), a counter value, an uplink direction flag, or a downlink direction flag.

In some embodiments, the authentication request message carries a key identifier of the first key.

In some embodiments, the network device includes a policy control function (PCF) or a network exposure function (NEF).

In the embodiments, an information protection method is provided, the method includes:
receiving, by a second device, first information with the security protection from a first device; and
sending, by the second device, the first information with the security protection to a third device.

In some embodiments, the security protection includes integrity protection and/or encryption.

In some embodiments, the first information with the security protection includes the first information and verification information, wherein the verification information is obtained by the first device processing the first information using a first key.

In some embodiments, the method further including:
receiving, by the second device, a key identifier of the first key from the first device.

In some embodiments, the key identifier of the first key is included in the first information; or the key identifier of the first key is independent of the first information.

In some embodiments, the second device includes an AF.

In some embodiments, the first device includes a terminal device, and the third device includes a network device.

In some embodiments, the first information includes user consent information.

In some embodiments, the first device includes a network device, and the third device includes a terminal device.

In some embodiments, the network device includes a policy control function (PCF) or a network exposure function (NEF).

In the embodiments, an information protection method is provided, the method includes:
sending, by a fourth device, an authentication request message to a terminal device, the authentication request message indicating the terminal device to generate a first key, and the first key being used to perform security protection on first information transmitted between the terminal device and a network device via a second device.

In some embodiments, the security protection includes integrity protection and/or encryption.

In some embodiments, the authentication request message includes a key identifier of the first key.

In some embodiments, the method further including:
receiving, by the fourth device, an authentication request response message from a fifth device, the authentication request response message carrying a first indication, and the first indication being used to indicate to generate the first key.

In some embodiments, the method further including:
generating, by the fourth device, the first key and/or a second key using parameters carried in the authentication request response message, the second key being used to generate the first key; and
sending, by the fourth device, at least one of the first key, the second key, or the key identifier of the first key.

In some embodiments, generating, by the fourth device, the first key and/or the second key using the parameters carried in the authentication request response message, includes:
generating, by the fourth device, a third key using the parameters carried in the authentication request response message; and
generating, by the fourth device, the first key and/or the second key using the third key and other parameters and adopting a key derivation function (KDF).

In some embodiments, the third key includes at least one of Kausf, Kakma, Kseaf, or Kamf.

In some embodiments, the other parameters include at least one of a user equipment (UE) identifier (ID), a random digit (RAND), a counter value, an uplink direction flag, or a downlink direction flag.

In some embodiments, the fourth device includes an authentication selection function (AUSF).

In the embodiments, an information protection method is provided, the method includes:
receiving, by a fifth device, an authentication request message; and
sending, by the fifth device, an authentication request response message, the authentication request response message carrying a first indication, and the first indication being used to indicate to generate a first key.

In some embodiments, the fifth device includes a (unified data management) UDM.

As shown in FIG. 3, in some implementations, a first key may be pre-derived in a key negotiation process of the 5G AKA for performing integrity protection and/or integrity verification during subsequent transmission of the first information in the embodiments of the present application. A derived first key may be obtained by the first device and the third device, but cannot be obtained by the AF. Therefore, if the third device successfully verifies the first information by using the first key, it can be determined that the first information is information authentically sent by the first device, rather than information tampered with or forged by the AF. Furthermore, corresponding indications may be added during a UE registration process to trigger derivation of the first key in the embodiment of the present application.

The following introduces the information protection method proposed in the embodiments of the present application from perspectives of an information sending terminal (such as a first device), an information receiving terminal (such as a third device), an information forwarding device (such as a second device), and devices involved in a derivation process of the first key, respectively.

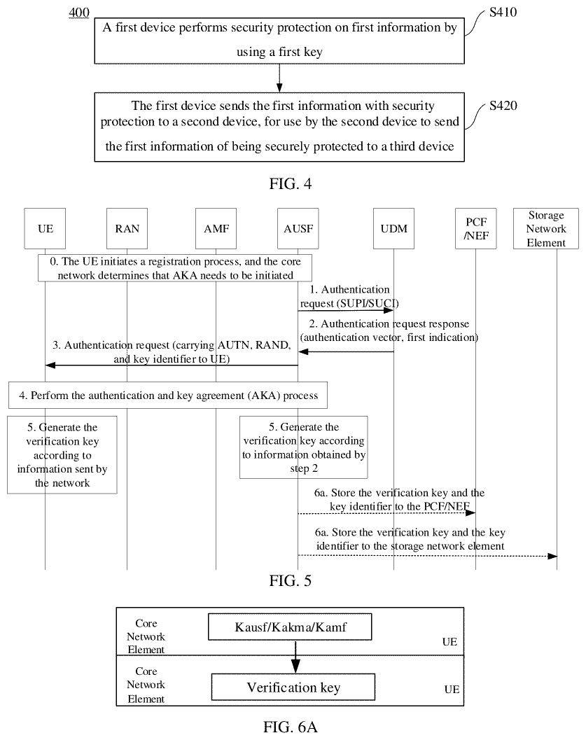

FIG. 4 is a schematic flowchart showing an information protection method, in accordance with an embodiment of the present application. The method may optionally be applied to the system shown in FIG. 1, but is not limited thereto. The method includes at least part of the following content.

S410: A first device performs security protection on first information by using a first key.

S420: The first device sends the first information with security protection to a second device, for use by the second device to send the first information with security protection to a third device.

The first device may be an information sending terminal, such as a terminal device or a network device; the second device may be an information forwarding device; and the third device may be an information sending terminal, such as a terminal device or a network device.

In an implementation, the security protection includes integrity protection and/or encryption.

The first key may be distributed in advance to the first device and the third device, and the second device cannot obtain the first key. Therefore, in a case where the security protection is the integrity protection, if the third device successfully verifies the first information with security protection by using the first key, it can be determined that the first information is information authentically sent by the first device, and is not information tampered with or forged by the second device. In a case where the security protection is the encryption, since the second device cannot obtain the first key, it cannot read or tamper with the first information forwarded by the second device, so the first information may be securely transmitted between the sending terminal (the first device) and the receiving terminal (the third device).

In an implementation, the first device performs the security protection on the first information by using the first key, which includes: processing, by the first device, the first information by using the first key, to obtain verification information; and
the first device sends the first information with security protection, which includes: sending, by the first device, the first information and the verification information.

Correspondingly, the third device as the receiving terminal may verify the first information with security protection. For example, the third device receives the first information with security protection from the second device, and performs integrity verification and/or decryption on the first information with security protection by using the first key.

In some embodiments, the third device may perform integrity verification and/or decryption on the first information with security protection by using the first key, which includes: processing, by the third device, the first information by using the first key, comparing, by the third device, a processing result with the verification information, and determining, by the third device, integrity of the first information according to a comparison result.

In another implementation, the first device performs the security protection on the first information by using the first key, which includes: performing, by the first device, encryption on the first information by using the first key, to obtain encrypted first information; and
the first device sends the first information with security protection, which includes:
sending, by the first device, the encrypted first information.

Correspondingly, the third device as the receiving terminal may perform decryption on the first information with security protection. For example, the third device receives the encrypted first information from the second device and performs decryption on the encrypted first information by using the first key.

In some implementations, the method may further include: sending, by the first device, a key identifier of the first key to the second device. The key identifier of the first key may be forwarded by the second device to the third device.

In some implementations, the key identifier of the first key may be included in the first information; or the key identifier of the first key may be independent of the first information.

In the embodiments of the present application, the first key may be derived during interaction between the terminal device and the 5GC, that is, in the AKA process. In the related art, a key generated in the AKA process are mainly used for encryption and integrity protection of an NAS message and a radio message. The embodiments of the present application provide that a set of new keys (such as the first key) may be additionally derived in the AKA process, which is stored in the UE and 5GC, and is used in subsequent message interaction between the UE and the network device. In the subsequent message interaction, a message transmitting terminal (which may be the UE or network device) performs encryption or integrity protection (signature) using the key, and then sends a message to the AF. The AF then sends this message to a message receiving terminal (which may be the UE or the network device), and the message receiving terminal performs decryption or verification on a received message using a previously derived first key. A sending path of the message may be: the UE->the AF->the core network, or the core network->the AF->the UE.

FIG. 5 is a schematic flowchart showing a derivation process of a first key in an information protection method, in accordance with an embodiment of the present application. The following steps are included.

Step 1, an authentication selection function (AUSF) sends an authentication request message to a unified data management (user data management, UDM), where the authentication request message carries a UE ID (such as SUPI/SUCI).

Step 2, the UDM responses an authentication request response message to the AUSF. The authentication request response message carries a corresponding authentication vector (AV). The authentication vector may include a random digit (RAND), an authentication token (AUthentication TokeN, AUTN), XRES*, KAUSF, or the like. The authentication request response message may further carry a first indication, where the first indication is used to indicate that a first key (such as a verification key) and/or a key identifier of the first key needs to be derived. The first indication may be part of subscription information or UE policy.

Step 3, a core network element (such as the AUSF) sends the authentication request message to the terminal. The authentication request message may include parameters required by AKA such as AUTN, RAND, or the like, may further include a key identifier to indicate the terminal to derive the first key (such as the verification key), and may also be used to identify parameters of a generated verification key.

The key identifier may be one parameter or two parameters, which may indicate that the terminal needs to derive the first key (such as the verification key) in an aspect, and may be used to identify the generated first key (such as the verification key) in another aspect.

Additionally, the key identifier may be an optional parameter. If the authentication request message sent by the core network element to the terminal does not include a key identifier, the terminal may generate the first key (such as the verification key) according to other implicit or explicit indication information, or generate the first key (such as the verification key) by default, and use a terminal identifier (such as the UE ID) to identify the first key (such as the verification key).

Steps 4 and 5, the UE and the network side (such as the AUSF) perform an AKA process, and respectively use the parameters of RAND and AUTN to generate keys of integrity protection and encryption for the NAS and radio (such as Knasint, Knasenc, Kcpenc, Kcpint, Kupenc, or Kupint). Alternatively, the UE and the network side (such as the AUSF) may use the above key or one of the key of a certain level in the AKA process (such as Kausf, Kakma, Kseaf, or Kamf) to further derive the first key (such as the verification key).

Step 6, the network side (such as the AUSF) sends the derived first key (such as the verification key) or an intermediate key used to generate the first key (such as a second key), and the key identifier of the first key to the core network device (such as the PCF/NEF) or other storage network elements for use by the terminal device and the core network device to protect information in subsequent transmission of the information. A storage network element may be a new network element or an existing network element, and is used to store the verification key and/or a verification identifier.

In steps 4 and 5, the UE and the network side (such as the AUSF) derive the first key (such as the verification key) in at least the following methods.

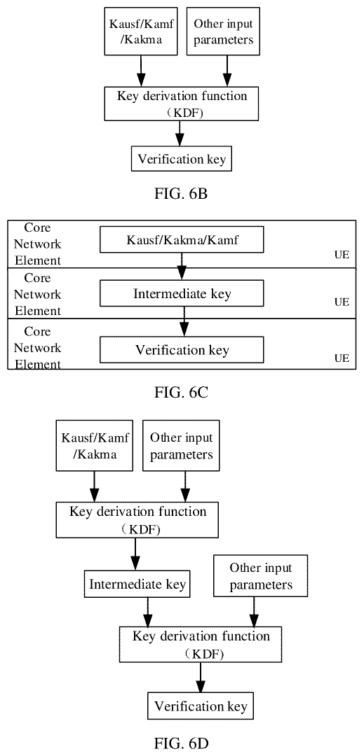

Method 1: FIG. 6A is a schematic diagram showing a first method for deriving a verification key in an information protection method, in accordance with an embodiment of the present application. As shown in FIG. 6A, the core network element and the UE may respectively use a key of a certain level (such as one of Kausf, Kakma, Kseaf, and Kamf) in the AKA process to generate the verification key.

Method 2: FIG. 6B is a schematic diagram showing a second method for deriving a verification key in an information protection method, in accordance with an embodiment of the present application. As shown in FIG. 6B, the core network element and the UE may respectively use a key of a certain level in the AKA process (such as one of Kausf, Kakma, Kseaf, and Kamf) and other input parameters, and adopt a key derivation function (KDF) to generate the verification key.

Method 3: FIG. 6C is a schematic diagram showing a third method for deriving a verification key in an information protection method, in accordance with an embodiment of the present application. As shown in FIG. 6C, the core network element and the UE may respectively use a key of a certain level in the AKA process (such as one of Kausf, Kakma, Kseaf, and Kamf) to generate an intermediate key, and then respectively use the intermediate key to generate the verification key.

Method 4, FIG. 6D is a schematic diagram showing a fourth method for deriving a verification key in an information protection method, in accordance with an embodiment of the present application. As shown in FIG. 6D, the core network element and the UE may respectively use a key of a certain level in the AKA process (such as one of Kausf, Kakma, Kseaf, Kamf) and other input parameters, and adopt a KDF to generate an intermediate key; and then use the intermediate key and other input parameters, and adopt the KDF to generate the verification key.

Among the above methods, Kakma is generated by the 5G core network element based on Kausf in another separate process from the AKA process.

In the above-mentioned methods, a generated key of each level (such as the verification key or the intermediate key) requires not only a key of a previous level as input, but also “other input parameters” as input information for deriving this key. The “other input parameters” include but are not limited to: a UE ID (such as SUPI), RAND, a counter value (Count), an uplink or downlink direction flag, etc.

Applying the above-mentioned method of deriving the first key (such as the verification key), in some implementations, in a case where the first device is a terminal device, the information protection method provided in the embodiments of the present application may further include:
receiving, by the terminal device, an authentication request message; and
generating, by the terminal device, the first key and/or a second key using parameters carried in the authentication request message, where the second key is used to generate the first key.

For example, the second key may be the intermediate key in Method 3 and Method 4 described above.

In some embodiments, generating, by the terminal device, the first key and/or the second key using the parameters carried in the authentication request message, may include: generating, by the terminal device, a third key using the parameters carried in the authentication request message; and generating, by the terminal device, the first key and/or the second key using the third key and other parameters and adopting the KDF.

Herein, the third key may include at least one of Kausf, Kakma, Kseaf, or Kamf.

The other parameters may include at least one of a UE ID, an RAND, a counter value, an uplink direction flag, or a downlink direction flag.

Applying the above-mentioned method of deriving the first key (such as the verification key), in some implementations, in a case where the first device is a network device, the information protection method provided in the embodiments of the present application may further include: receiving and storing, by the network device, the first key and a key identifier of the first key; or receiving and storing, by the network device, a second key and a key identifier of the first key, where the second key is used to generate the first key. In a subsequent process of the network device performing security protection on the first information, the network device may obtain the first key from a storage network element before performing the security protection on the first information, and/or, may obtain the first key from the storage network element according to a predetermined period. Alternatively, the network device may obtain a second key from the storage network element before performing the security protection on the first information, and use the second key to generate the first key; and/or, the network device may obtain the second key from the storage network element according to a predetermined period, and use the second key to generate the first key.

The first key (such as the verification key) may include at least one of the following two keys:
an integrity protection key (or a signature key), which is used by a receiving terminal device (such as the third device) to verify that information sent by the second device (such as the AF) is provided by a sending terminal device (such as the first device); or
an encryption key, which is used by a receiving terminal device (such as the third device) to decrypt information sent by the second device (such as the AF) and provided by a sending terminal device (such as the first device).

In some implementations, the above-mentioned various derivation methods of the verification key may occur after AKA authentication is passed.

In some implementations, the first device and/or the third device may generate a verification key using the intermediate key in the above-mentioned Method 3 and Method 4 in a case of performing security protection and/or verification on transmitted information. Corresponding to this case, the second key (such as the intermediate key) may be generated and sent in steps 5 and 6 (including steps 6a and 6b) in the process shown in FIG. 5. Subsequently, when performing security protection and/or verification on the transmitted information, the terminal device or the network device uses the second key to generate the first key (such as the verification key); or the terminal device or the network device regularly uses the second key to generate the first key (such as the verification key), and uses the first key (such as the verification key) when performing security protection the transmitted information; or the terminal device or the network device may use the second key to generate the first key (such as the verification key) when receiving information with protection, and performing decryption and/or verification on the information with protection by using the first key.

The following describes some exemplary implementations for performing security protection on transmitted information by using the first key.

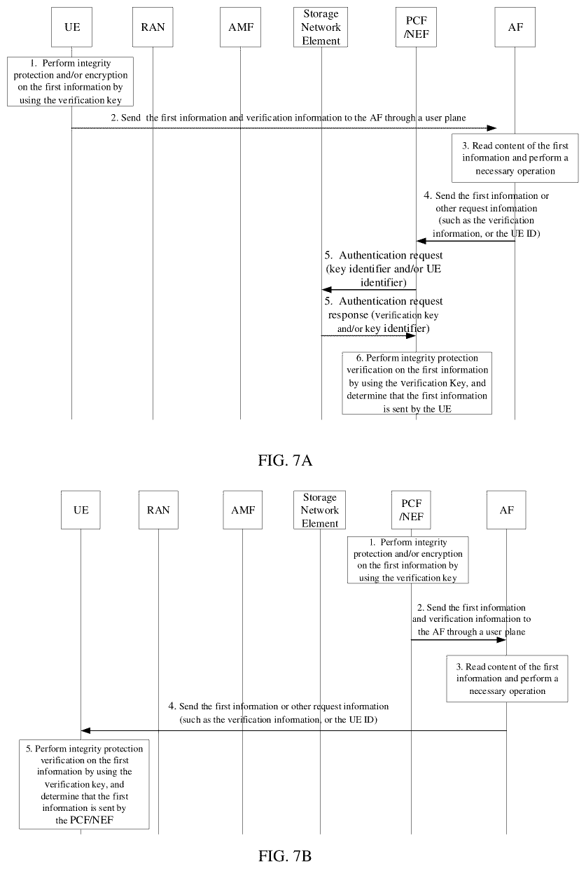

FIG. 7A is a schematic flowchart showing performing security protection on first information and transmitting the first information in an information protection method, in accordance with an embodiment of the present application. FIG. 7A takes performing uplink transmission and performing integrity protection on transmitted information as an example for introduction, and includes the following steps.

Step 1: The UE performs integrity protection on the first information by using the first key (such as the verification key). For example, the first key is used to process the first information to obtain the verification information, and the verification information may be a MAC (or a signature). In the embodiments, the first information is user consent information, such as services and functions that a user consents to perform, whether the user consents to use the user's own data, and a type of data that the user consents to use, so that the 5G network also performs related operations (such as providing certain UE data to the AF, or enabling certain corresponding services). If key derivation methods of the above-mentioned Method 3 and Method 4 are adopted, that is, the intermediate key is first derived and then the first key is generated using the intermediate key, the UE may generate the first key using the intermediate key before sending the first information to the AF, or regularly generate the first key using the intermediate key. The security protection in the embodiments may further include encryption. For example, if both the AF and the 5G network are required to be able to read the first information, the first information is only performed with integrity protection and not performed with encryption; and if only the 5G network is expected to be able to read the first information, the first information is performed with both integrity protection and encryption.

Step 2: The UE sends the first information with security protection to the AF through an established user plane connection. The user plane connection may refer to an HTTP connection of an application layer or a PDU session of a 3GPP protocol. For example, the first information and the verification information are sent to the AF. The first information with security protection may include the first information and the verification information. In addition, the UE may also send a key identifier of the first key to the AF. The key identifier of the first key may be included in the first information; or the key identifier of the first key may be independent of the first information, such as being sent separately using another message.

Step 3: AF reads content of the first information and performs a necessary operation according to the content of the first information.

Step 4: The AF sends the first information or a request message including the first information to a core network device (such as the PCF/NEF). The AF may further send other request information (such as the verification information, and the UE ID) to the core network device (such as the PCF/NEF). The first information may include the key identifier of the first key, or the key identifier of the first key may be independent of the first information.

Step 5: The core network device (such as the PCF/NEF) sends a key request message to a storage network element, where the key request message may include the key identifier of the first key and/or a UE identifier. The storage network element feeds back a key request response message to the core network device (such as the PCF/NEF), where the key request response message carries the first key and/or the key identifier of the first key, or carries the first key and/or the UE identifier (in this case, the first key is identified by the UE identifier). If the core network device (such as the PCF/NEF) itself stores the first key, the core network device (such as the PCF/NEF) does not need to obtain the first key from the storage network element, and may directly perform verification by using the first key; or if the core network device (such as the PCF/NEF) itself stores an intermediate key for generating the first key, the core network device (such as the PCF/NEF) does not need to obtain the first key from the storage network element, and may use the intermediate key to generate the first key, and perform verification on the first information by using the first key.

Step 6: The core network device (such as the PCF/NEF) performs integrity protection verification on the first information by using the first key. For example, the first key is used to process the first information to obtain the verification information (such as XMAC), and then the XMAC is compared with the verification information (such as the MAC or signature) received in step 4. If a comparison result is consistent, the core network device (such as the PCF/NEF) may determine that the first information is authentic information sent by the UE.

FIG. 7B is a schematic flowchart showing performing security protection on first information and transmitting the first information in an information protection method, in accordance with an embodiment of the present application. FIG. 7B takes performing downlink transmission and performing integrity protection on transmitted information as an example for introduction, and includes the following steps.

Step 1: A core network element (such as the PCF/NEF) performs integrity protection on the first information by using a first key (such as the verification key). For example, the first key is used to process the first information to obtain the verification information, and the verification information may be a MAC (or a signature). If key derivation methods of the above-mentioned Method 3 and Method 4 are adopted, that is, the intermediate key is first derived and then the first key is generated using the intermediate key, the PCF/NEF may generate the first key using the intermediate key before sending the first information to the AF, or regularly generate the first key using the intermediate key. The security protection in the embodiments may further include encryption. For example, if both the AF and the 5G network are required to be able to read the first information, the first information is only performed with integrity protection and not performed with encryption; and if only the 5G network is expected to be able to read the first information, the first information is performed with both integrity protection and encryption.

Step 2: The core network element (such as the PCF/NEF) sends the first information with security protection to the AF. For example, the first information and the verification information are sent to the AF. The first information with security protection may include the first information and the verification information. In addition, the core network element may also send a key identifier of the first key to the AF. The key identifier of the first key may be included in the first information; or the key identifier of the first key may be independent of the first information, such as being sent separately using another message.

Step 3: AF reads content of the first information and performs a necessary operation according to the content of the first information.

Step 4: The AF sends the first information or a request message including the first information to a UE. The AF may further send other request information (such as the verification information) to the UE. The first information may include the key identifier of the first key, or the key identifier of the first key may be independent of the first information.

Step 5: The UE performs verification on the first information by using the first key; or if the UE stores an intermediate key for generating the first key, the UE may use the intermediate key to generate the first key, and perform verification on the first information by using the first key.

For example, the UE uses the first key to process the first information to obtain the verification information (such as XMAC), and then compares the XMAC with the verification information (such as the MAC or signature) received in step 4. If a comparison result is consistent, the UE may determine that the first information is authentic information sent by the core network element (such as the PCF/NEF).

As can be seen from above, a verification key is used to verify the validity of information forwarded between a terminal device and a network device via other devices (such as the AF) in the embodiments of the present application, that is, the verification key is used to perform integrity protection on sent information. If necessary, the sent information may also be encrypted using the verification key. Regarding the keys used for security protection, in the embodiments of the present application, the AKA mechanism in the current 5G network can utilized to generate new verification keys based on this mechanism for verifying authenticity of information, such as verifying that information provided by the AF to the 5G network is authentic information provided by the UE. In the embodiments of the present application, a symmetric key derivation method may be adopted, so that a message after performing integrity protection may still be read by the AF and then verified by the receiving terminal (such as the network device or the terminal device), and relevant information is read when the UE interacts with the AF, and the AF interacts with the 5G network.

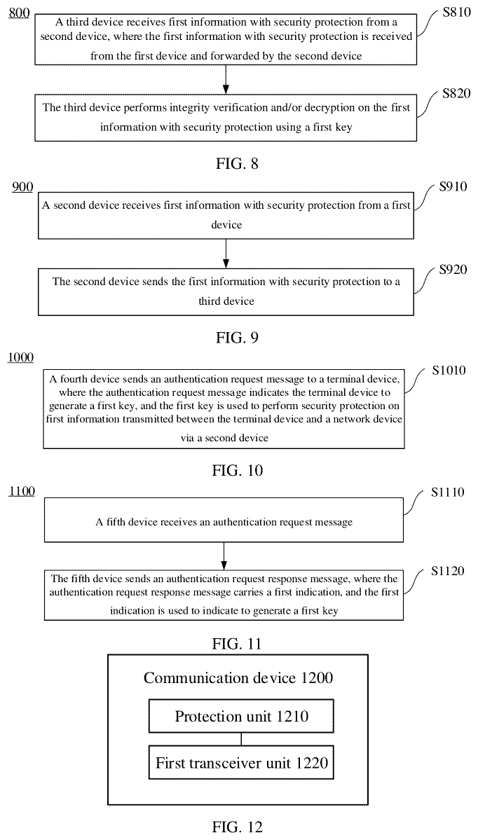

The embodiments of the present application further provide an information protection method. FIG. 8 is a schematic flowchart showing an information protection method 800, in accordance with an embodiment of the present application. The method may optionally be applied to the system shown in FIG. 1, but is not limited thereto. The method includes at least part of the following content.

S810: A third device receives first information with security protection from a second device, where the first information with security protection is received from the first device and forwarded by the second device.

S820: The third device performs integrity verification and/or decryption on the first information with security protection using a first key.

The third device may be an information receiving terminal, such as a terminal device or a network device; the second device may be an information forwarding device; and the first device may be an information sending terminal, such as a terminal device or a network device.

In some embodiments, the security protection includes at least one of integrity protection or encryption.

The first key may be distributed in advance to the first device and the third device, and the second device cannot obtain the first key. Therefore, in a case of the integrity protection, if the third device successfully verifies the first information with security protection by using the first key, it can be determined that the first information is information authentically sent by the first device, and is not information tampered with or forged by the second device. In a case of the encryption, since the second device cannot obtain the first key, it cannot read the first information forwarded by the second device, so the first information may be securely transmitted between the sending terminal (the first device) and the receiving terminal (the third device).

In some implementations, the third device receives the first information with security protection from the second device, which includes: receiving, by the third device, the first information and the verification information from the second device, where the verification information is obtained by the first device processing the first information by using the first key; and
the third device performs the integrity verification on the first information with security protection by using the first key, which includes: processing, by the third device, the first information by using the first key, comparing, by the third device, a processing result with the verification information, and determining, by the third device, integrity of the first information according to a comparison result.

In some implementations, the method may further include: receiving, by the third device, a key identifier of the first key from the second device. The key identifier of the first key may be sent from the first device to the second device.

In some implementations, the key identifier of the first key is included in the first information; or the key identifier of the first key is independent of the first information.

In some implementations, the third device includes a network device, and the first device includes a terminal device.

In some implementations, the first information includes user consent information.

In some embodiments, the method further includes at least one of the following:
determining, by the network device, the first key using the key identifier of the first key;
obtaining, by the network device, the first key from a storage network element using the key identifier of the first key;
determining, by the network device, a second key using the key identifier of the first key, and generating, by the network device, the first key using the second key; or
obtaining, by the network device, the second key from the storage network element using the key identifier of the first key, and generating, by the network device, the first key using the second key.

In the embodiments of the present application, the first key may be derived during interaction between the terminal device and the 5G core network (5G Core, 5GC), that is, in the AKA process. In the related art, a key generated in the AKA process are mainly used for encryption and integrity protection of an NAS message and a radio message. The embodiments of the present application provide that a set of new keys (such as the first key) may be additionally derived in the AKA process, which is stored in the UE and 5GC. In subsequent message interaction between the UE and the network device, the key is used to perform encryption and integrity protection on an interacted message.

Correspondingly, in some implementations, the method may further include:
receiving and storing, by the network device, the first key and the key identifier of the first key; or
receiving and storing, by the network device, the second key and the key identifier of the first key, where the second key is used to generate the first key.

In some other implementations, the third device includes the terminal device, and the first device includes the network device.

In some implementations, the method may further include at least one of the following:
determining, by the terminal device, the first key using the key identifier of the first key; or
determining, by the terminal device, the second key using the key identifier of the first key, and generating, by the terminal device, the first key using the second key.

Similarly, the terminal device may also derive the first key during the interaction between the terminal device and 5GC, that is, in the AKA process. For example, the method may further include: receiving, by the terminal device, an authentication request message; and
generating, by the terminal device, the first key and/or the second key using parameters carried in the authentication request message, where the second key is used to generate the first key.

In some implementations, generating, by the terminal device, the first key and/or the second key using the parameters carried in the authentication request message, includes:
generating, by the terminal device, a third key using the parameters carried in the authentication request message; and
generating, by the terminal device, the first key and/or the second key using the third key and other parameters and adopting a KDF.

In some implementations, the third key includes at least one of Kausf, Kakma, Kseaf, or Kamf.

In some implementations, the other parameters include at least one of a user equipment (UE) identifier (ID), a random digit (RAND), a counter value, an uplink direction flag, or a downlink direction flag.

In some implementations, the authentication request message carries the key identifier of the first key.

In the above implementations, the network device may include a PCF or an NEF.

Exemplary examples of the third device performing the method 800 of the embodiments may be found in relevant descriptions of the third device (which may be the terminal device or the network device) in the above implementations, which will not be repeated here for brevity.

The embodiments of the present application further provide an information protection method. FIG. 9 is a schematic flowchart showing an information protection method 900, in accordance with an embodiment of the present application. The method may optionally be applied to the system shown in FIG. 1, but is not limited thereto. The method includes at least part of the following content.

S910: A second device receives first information with security protection from a first device.

S920: The second device sends the first information with security protection to a third device.

The first device may be an information sending terminal, such as a terminal device or a network device; the second device may be an information forwarding device, such as an AF; the third device may be an information receiving terminal, such as a terminal device or a network device.

In some implementations, security protection includes at least one of integrity protection or encryption.

In some implementations, the first information with security protection includes the first information and verification information. The verification information is obtained by the first device processing the first information using a first key.

In some implementations, the method further includes: receiving, by the second device, a key identifier of the first key from the first device.

The key identifier of the first key may be included in the first information; or the key identifier of the first key is independent of the first information.

In some implementations, the first device includes a terminal device, and the third device includes a network device.

In some implementations, the first information includes user consent information.

In some implementations, the first device includes a network device, and the third device includes a terminal device.

The network device may include a PCF or an NEF.

Exemplary examples of the second device performing the method 900 of the embodiments may be found in relevant descriptions of the second device (which may be the AP) in the above implementations, which will not be repeated here for brevity.

The embodiments of the present application further provide an information protection method. FIG. 10 is a schematic flowchart showing an information protection method 1000, in accordance with an embodiment of the present application. The method includes at least part of the following content.

S1010: A fourth device sends an authentication request message to a terminal device, where the authentication request message indicates the terminal device to generate a first key, and the first key is used to perform security protection on first information transmitted between the terminal device and a network device via a second device.

The fourth device may be an AUSF.

In some implementations, the security protection includes integrity protection and/or encryption.

In some implementations, the authentication request message includes a key identifier of the first key.

In some implementations, the method further includes: receiving, by the fourth device, an authentication request response message from a fifth device. The authentication request response message carries a first indication, where the first indication is used to indicate to generate the first key.

Herein, the fifth device may be a UDM.

In some implementations, the method further includes:
generating, by the fourth device, the first key and/or a second key using parameters carried in the authentication request response message, where the second key is used to generate the first key; and
sending, by the fourth device, at least one of the first key, the second key, or the key identifier of the first key.

In some embodiments, the fourth device may send at least one of the first key, the second key, and the key identifier of the first key to the core network device or other storage network elements.

In some implementations, generating, by the fourth device, the first key and/or the second key using the parameters carried in the authentication request response message, includes:
generating, by the fourth device, a third key using the parameters carried in the authentication request response message; and
generating, by the fourth device, the first key and/or the second key using the third key and other parameters and adopting a key derivation function (KDF).

In some implementations, the third key includes at least one of Kausf, Kakma, Kseaf, or Kamf.

In some implementations, the other parameters include at least one of a user equipment (UE) identifier (ID), a random digit (RAND), a counter value, an uplink direction flag, or a downlink direction flag.

Exemplary examples of the fourth device performing the method 1000 of the embodiments may be found in relevant descriptions of the fourth device (which may be the AUSF) in the above implementations, which will not be repeated here for brevity.

The embodiments of the present application further provide an information protection method. FIG. 11 is a schematic flowchart showing an information protection method 1100, in accordance with an embodiment of the present application. The method includes at least part of the following content.

S1110: A fifth device receives an authentication request message.

S1120: The fifth device sends an authentication request response message, where the authentication request response message carries a first indication, and the first indication is used to indicate to generate a first key.

In some implementations, the fifth device may include a UDM.

Exemplary examples of the fifth device performing the method 1100 of the embodiments may be found in relevant descriptions of the fifth device (which may be the UDM) in the above implementations, which will not be repeated here for brevity.

FIG. 12 is a schematic block diagram showing a communication device 1200, in accordance with an embodiment of the present application. The communication device 1200 may include:
a protection unit 1210, configured to perform security protection on the first information by using the first key; and
a first transceiver unit 1220, configured to send the first information with security protection to the second device, for use by the second device to send the first information with security protection to the third device.

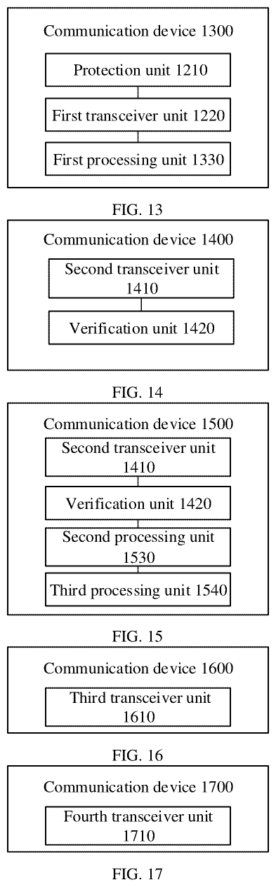

The embodiments of the present application further provide another communication device. FIG. 13 is a schematic structure diagram showing a communication device 1300, in accordance with an embodiment of the present application. The communication device 1300 may include:
a protection unit 1210, a first transceiver unit 1220 and a first processing unit 1330, where the protection unit 1210 and the first transceiver unit 1220 are the same as the corresponding modules mentioned above and are not described in detail here.

In some implementations, the security protection includes integrity protection and/or encryption.

In some implementations, the protection unit 1210 is configured to perform the first information by using the first key, to obtain the verification information; and the first transceiver unit 1220 is configured to send the first information and the verification information.

In some implementations, the protection unit 1210 is configured to perform encryption on the first information by using the first key, to obtain the encrypted first information; and the first transceiver unit 1220 is configured to send the encrypted first information.

In some implementations, the first processing unit 1330 is configured to generate the first key using the second key.

In some implementations, the first processing unit 1330 is configured to:
generate the first key using the second key before performing the security protection on the first information; and/or
generated the first key using the second key according to the predetermined period.

In some implementations, the first transceiver unit 1220 is further configured to send the key identifier of the first key to the second device.

In some implementations, the key identifier of the first key is included in the first information; or the key identifier of the first key is independent of the first information.

In some implementations, the communication device 1300 includes the terminal device, and the third device includes the network device.

In some implementations, the first information includes the user consent information.

In some implementations, the first transceiver unit 1220 is configured used to receive the authentication request message; and
the first processing unit 1330 is used to generate the first key and/or the second key using the parameters carried in the authentication request message, where the second key is used to generate the first key.

In some implementations, the first processing unit 1330 is configured to:
generate the third key using the parameters carried in the authentication request message; and
generate the first key and/or the second key using the third key and other parameters and adopting the key derivation function (KDF).

In some implementations, the third key includes at least one of Kausf, Kakma, Kseaf, or Kamf.

In some implementations, the other parameters include at least one of the user equipment (UE) identifier (ID), the random digit (RAND), the counter value, the uplink direction flag, or the downlink direction flag.

In some implementations, the authentication request message carries the key identifier of the first key.

In some implementations, the communication device 1300 includes the network device, and the third device includes the terminal device.

In some implementations, the first transceiver unit 1220 is configured to obtain the first key from the storage network element.

In some implementations, the first transceiver unit 1220 is configured to:
obtain the first key from the storage network element before performing the security protection on the first information; and/or
obtain the first key from the storage network element according to the predetermined period.

In some implementations, the first transceiver unit 1220 is configured to:
receive and store the first key and the key identifier of the first key; or
receive and store the second key and the key identifier of the first key, where the second key is used to generate the first key.

In some implementations, the network device includes the policy control function (PCF) or the network exposure function (NEF).

The communication device 1200 and the communication device 1300 in the embodiments of the present application are able to implement corresponding functions of the first device in the aforementioned method embodiments. The process, function, implementation, and beneficial effect corresponding to each module (sub-module, unit or component) in the communication device 1200 and communication device 1300 can be found in corresponding descriptions in the aforementioned method embodiments, and will not be repeated here. It will be noted that the functions described in the various modules (sub-modules, units or components) in the communication device 1200 and communication device 1300 in the embodiments of the present application may be implemented by different modules (sub-modules, units or components) or by the same module (sub-module, unit or component).

FIG. 14 is a schematic block diagram showing a communication device 1400, in accordance with an embodiment of the present application. The communication device 1400 may include:
a second transceiver unit 1410, configured to receive the first information with security protection from the second device, where the first information with security protection is received from the first device and forwarded by the second device; and
a verification unit 1420, configured to perform integrity verification and/or decryption on the first information with security protection by using the first key.

The embodiments of the present disclosure further provide another communication device. FIG. 15 is a schematic structure diagram showing a communication device 1500, in accordance with an embodiment of the present application. The communication device 1500 may include:
a second transceiver unit 1410, a verification unit 1420, a second processing unit 1530, and a third processing unit 1540, where the second transceiver unit 1410 and the verification unit 1420 are the same as the corresponding modules mentioned above and are not described in detail here.

In some implementations, the security protection includes at least one of integrity protection or encryption.

In some implementations, the second transceiver unit 1410 is configured to receive the first information and the verification information from the second device, where the verification information is obtained by the first device processing the first information by using the first key; and the verification unit 1420 is configured to: process the first information by using the first key, compare the processing result with the verification information, and determine integrity of the first information according to the comparison result.

In some implementations, the second transceiver unit 1410 is further configured to receive the key identifier of the first key from the second device.

In some implementations, the key identifier of the first key is included in the first information; or the key identifier of the first key is independent of the first information.

In some implementations, the communication device 1400 includes the network device, and the first device includes the terminal device.

In some implementations, the first information includes the user consent information.

In some implementations, the second processing unit 1530 is configured to at least one of the following:
determine the first key using the key identifier of the first key;
obtain the first key from the storage network element using the key identifier of the first key;
determine the second key using the key identifier of the first key, and generate the first key using the second key; or
obtain the second key from the storage network element using the key identifier of the first key, and generate the first key using the second key.

In some implementations, the second transceiver unit 1410 is configured to:
receive and store the first key and the key identifier of the first key; or
receive and store the second key and the key identifier of the first key, where the second key is used to generate the first key.

In some implementations, the communication device 1500 includes the terminal device, and the first device includes the network device.

In some implementations, the third processing unit 1540 is configured to: determine the first key using the key identifier of the first key; or determine the second key using the key identifier of the first key, and generate the first key using the second key.

In some implementations, the second transceiver unit 1410 is configured to receive the authentication request message; and
the third processing unit 1530 is configured to generate the first key and/or the second key using the parameters carried in the authentication request message, where the second key is used to generate the first key.

In some implementations, the third processing unit 1540 is configured to:
generate the third key using the parameters carried in the authentication request message; and
generate the first key and/or the second key using the third key and other parameters and adopting the key derivation function (KDF).

In some implementations, the third key includes at least one of Kausf, Kakma, Kseaf, or Kamf.

In some implementations, the other parameters include at least one of the user equipment (UE) identifier (ID), the random digit (RAND), the counter value, the uplink direction flag, or the downlink direction flag.

In some implementations, the authentication request message carries the key identifier of the first key.

In some implementations, the network device includes the policy control function (PCF) or the network exposure function (NEF).

The communication device 1400 and communication device 1500 in the embodiments of the present application are able to implement corresponding functions of the third device in the aforementioned method embodiments. The process, function, implementation, and beneficial effect corresponding to each module (sub-module, unit or component) in the communication device 1400 and communication device 1500 can be found in corresponding descriptions in the aforementioned method embodiments, and will not be repeated here. It will be noted that the functions described in the various modules (sub-modules, units or components) in the communication device 1400 and communication device 1500 in the embodiments of the present application may be implemented by different modules (sub-modules, units or components) or by the same module (sub-module, unit or component).

FIG. 16 is a schematic block diagram showing a communication device 1600, in accordance with an embodiment of the present application. The communication device 1600 may include:
a third transceiver unit 1610, configured to receive the first information with security protection from the first device; and send the first information with security protection to the third device.

In some implementations, the security protection includes at least one of integrity protection or encryption.

In some implementations, the first information with security protection includes the first information and the verification information, where the verification information is obtained by the first device processing the first information by using the first key.

In some implementations, the third transceiver unit 1610 is configured to receive the key identifier of the first key from the first device.

In some implementations, the key identifier of the first key is included in the first information; or the key identifier of the first key is independent of the first information.

In some embodiments, the communication device 1600 further includes the AF.

In some implementations, the first device includes the terminal device, and the third device includes the network device.

In some implementations, the first information includes the user consent information.

In some implementations, the first device includes the network device, and the third device includes the terminal device.

In some implementations, the network device includes the policy control function (PCF) or network exposure function (NEF).

The communication device 1600 in the embodiments of the present application are able to implement corresponding functions of the second device in the aforementioned method embodiments. The process, function, implementation, and beneficial effect corresponding to each module (sub-module, unit or component) in the communication device 1600 can be found in corresponding descriptions in the aforementioned method embodiments, and will not be repeated here. It will be noted that the functions described in the various modules (sub-modules, units or components) in the communication device 1600 in the embodiments of the present application may be implemented by different modules (sub-modules, units or components) or by the same module (sub-module, unit or component).

FIG. 17 is a schematic block diagram showing a communication device 1700, in accordance with an embodiment of the present application. The communication device 1700 may include:
a fourth transceiver unit 1710, configured to send the authentication request message to the terminal device, where the authentication request message indicates the terminal device to generate the first key, and the first key is used to perform the security protection on the first information transmitted between the terminal device and the network device via the second device.

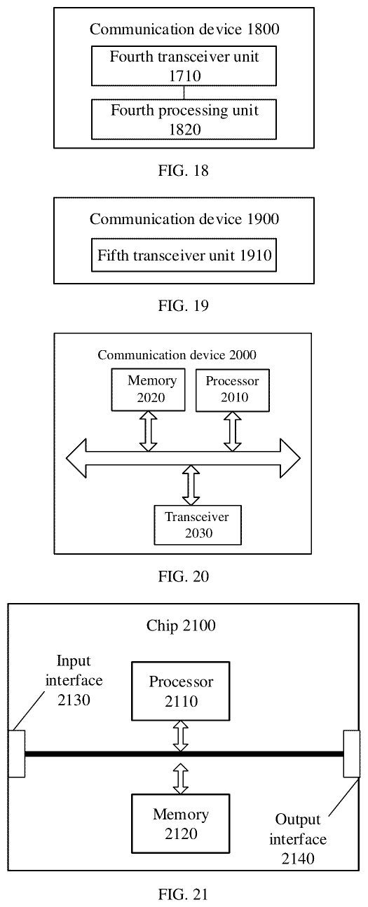

The embodiments of the present application further provide another communication device. FIG. 18 is a schematic structure diagram showing a communication device 1800, in accordance with an embodiment of the present application. The communication device 1800 may include:
a fourth transceiver unit 1710 and a fourth processing unit 1820, where the fourth transceiver unit 1710 is the same as the corresponding module and will not be described again.

In some implementations, the security protection includes integrity protection and/or encryption.

In some implementations, the authentication request message includes the key identifier of the first key.

In some implementations, the fourth transceiver unit 1710 is further configured to:
receive the authentication request response message from the fifth device, where the authentication request response message carries the first indication, and the first indication is used to indicate to generate the first key.

In some implementations, the fourth processing unit 1820 is configured to generate the first key and/or the second key using the parameters carried in the authentication request response message, where the second key is used to generate the first key; and
the fourth transceiver unit 1710 is further configured to send at least one of the first key, the second key or the key identifier of the first key.

In some implementations, the fourth processing unit 1820 is configured to:
generate the third key using the parameters carried in the authentication request response message; and
generate the first key and/or the second key by using the third key and other parameters and adopting the key derivation function (KDF).

In some implementations, the third key includes at least one of Kausf, Kakma, Kseaf, or Kamf.

In some implementations, the other parameters include at least one of the user equipment (UE) identifier (ID), the random digit (RAND), the counter value, the uplink direction flag, or the downlink direction flag.

In some implementations, the communication device 1800 includes the AUSF.

The communication device 1700 and communication device 1800 in the embodiments of the present application are able to implement corresponding functions of the fourth device in the aforementioned method embodiments. The process, function, implementation, and beneficial effect corresponding to each module (sub-module, unit or component) in the communication device 1700 and communication device 1800 can be found in corresponding descriptions in the aforementioned method embodiments, and will not be repeated here. It will be noted that the functions described in the various modules (sub-modules, units or components.) in the communication device 1700 and communication device 1800 in the embodiments of the present application may be implemented by different modules (sub-modules, units or components) or by the same module (sub-module, unit or component).

FIG. 19 is a schematic block diagram showing a communication device 1900, in accordance with an embodiment of the present application. The communication device 1900 may include:
a fifth transceiver unit 1910, configured to: receive the authentication request message; and send the authentication request response message, where the authentication request response message carries the first indication, and the first indication is used to indicate to generate the first key.

In some implementations, the communication device 1900 includes the UDM.

The communication device 1900 in the embodiments of the present application are able to implement corresponding functions of the fifth device in the aforementioned method embodiments. The process, function, implementation, and beneficial effect corresponding to each module (sub-module, unit or component) in the communication device 1900 can be found in corresponding descriptions in the aforementioned method embodiments, and will not be repeated here. It will be noted that the functions described in the various modules (sub-modules, units or components) in the communication device 1900 in the embodiments of the present application may be implemented by different modules (sub-modules, units or components) or by the same module (sub-module, unit or component).

FIG. 20 is a schematic structural diagram of a communication device 2000, in accordance with an embodiment of the present application. The communication device 2000 includes a processor 2010, and the processor 2010 may invoke and execute a computer program from a memory to cause the communication device 2000 to implement the methods in the embodiments of the present application.

In a possible implementation, the communication device may further include a memory 2020. The processor 2010 may invoke and execute the computer program from the memory 2020 to cause the communication device 2000 to implement the methods in the embodiments of the present application.

The memory 2020 may be a separate device independent of the processor 2010, or may be integrated into the processor 2010.

In a possible implementation, the communication device 2000 may further include a transceiver 2030. The processor 2010 may control the transceiver 2030 to communicate with other devices, for example, may control the transceiver 2030 to send information or data to other devices, or receive information or data sent by other devices.

The transceiver 2030 may include a transmitter and a receiver. The transceiver 2030 may further include antennas, the number of which may be one or more.

In a possible implementation, the communication device 2000 may be the first device of the embodiments of the present application, and the communication device 2000 may implement the corresponding processes implemented by the first device in each method of the embodiments of the present application, which will not be repeated here for brevity.

In a possible implementation, the communication device 2000 may be the second device of the embodiments of the present application, and the communication device 2000 may implement the corresponding processes implemented by the second device in each method of the embodiments of the present application, which will not be repeated here for brevity.

In a possible implementation, the communication device 2000 may be the third device of the embodiments of the present application, and the communication device 2000 may implement the corresponding processes implemented by the third device in each method of the embodiments of the present application, which will not be repeated here for brevity.

In a possible implementation, the communication device 2000 may be the fourth device of the embodiments of the present application, and the communication device 2000 may implement the corresponding processes implemented by the fourth device in each method of the embodiments of the present application, which will not be repeated here for brevity.

In a possible implementation, the communication device 2000 may be the fifth device of the embodiments of the present application, and the communication device 2000 may implement the corresponding processes implemented by the fifth device in each method of the embodiments of the present application, which will not be repeated here for brevity.

FIG. 21 is a schematic structural diagram showing a chip 2100, in accordance with an embodiment of the present application. The chip 2100 includes a processor 2110, which may invoke and execute a computer program from a memory to implement the methods in the embodiments of the present application.

In a possible implementation, the chip 2100 may further include a memory 2120. The processor 2110 may invoke and execute the computer program from the memory 2120 to implement the methods performed by the terminal device or the network device in the embodiments of the present application.

The memory 2120 may be a separate device independent of the processor 2110, or may be integrated into the processor 2110.

In a possible implementation, the chip 2100 may further include an input interface 2130. The processor 2110 may control the input interface 2130 to communicate with other devices or chips, for example, may control the input interface 2130 to obtain information or data sent by the other devices or chips.

In a possible implementation, the chip 2100 may further include an output interface 2140. The processor 2110 may control the output interface 2140 to communicate with other devices or chips, for example, may control the output interface 2140 to output information or data to the other devices or chips.

In a possible implementation, the chip may be applied to the first device in the embodiments of the present application, and the chip may implement the corresponding processes implemented by the first device in each method of the embodiments of the present application, which will not be repeated here for brevity.

In a possible implementation, the chip may be applied to the second device in the embodiments of the present application, and the chip may implement the corresponding processes implemented by the second device in each method of the embodiments of the present application, which will not be repeated here for brevity.

In a possible implementation, the chip may be applied to the third device in the embodiments of the present application, and the chip may implement the corresponding processes implemented by the third device in each method of the embodiments of the present application, which will not be repeated here for brevity.

In a possible implementation, the chip may be applied to the fourth device in the embodiments of the present application, and the chip may implement the corresponding processes implemented by the fourth device in each method of the embodiments of the present application, which will not be repeated here for brevity.

In a possible implementation, the chip may be applied to the fifth device in the embodiments of the present application, and the chip may implement the corresponding processes implemented by the fifth device in each method of the embodiments of the present application, which will not be repeated here for brevity.

The chips applied to the first device, the second device, the third device, the fourth device, and the fifth device may be the same chip or different chips.

It should be understood that the chip mentioned in the embodiments of the present application may also be referred toas a system-level chip, a system chip, a chip system, a system-on-chip, or the like.

The processor mentioned above may be a general-purpose processor, a digital signal processor (DSP), a field programmable gate array (FPGA), an application specific integrated circuit (ASIC), other programmable logic devices, a transistor logic device, a discrete hardware component, or the like. The general-purpose processor mentioned above may be a microprocessor or any conventional processor, or the like.

The memory mentioned above may be a volatile memory or non-volatile memory, or may include both volatile and non-volatile memories. Here, the non-volatile memory may be a read-only memory (ROM), a programmable ROM (PROM), an erasable programmable read-only memory (Erasable PROM, EPROM), an electrically erasable programmable read-only memory (Electrically EPROM, EEPROM) or a flash memory. The volatile memory may be a random access memory (RAM).

It should be understood that the above-mentioned memory is exemplary but not restrictive. For example, the memory in the embodiments of the present application can also be static random access memory (static RAM, SRAM), dynamic random access memory (dynamic RAM, DRAM), synchronous dynamic random access memory (synchronous DRAM, SDRAM), double data rate synchronous dynamic random access memory (double data rate SDRAM, DDR SDRAM), enhanced synchronous dynamic random access memory (enhanced SDRAM, ESDRAM), synchronous link dynamic random access memory (synch link DRAM, SLDRAM) and direct memory bus random access memory (Direct Rambus RAM, DR RAM), etc. That is, the memory in the embodiments of the present application is intended to include but is not limited to these and any other suitable types of memory.

The above embodiments may be implemented in whole or in part through software, hardware, firmware, or any combination thereof. When the embodiments are implemented by using a software program, the software program may be implemented in a form of a computer program product in whole or in part. The computer program product includes one or more computer instructions. When computer program instructions are loaded on and executed by a computer, processes or functions according to the embodiments of the present application are generated in whole or in part. The computer may be a general-purpose computer, a dedicated computer, a computer network, or any other programmable device. The computer instructions may be stored in a non-transitory computer-readable storage medium or transmitted from a non-transitory computer-readable storage medium to another non-transitory computer-readable storage medium. For example, the computer instructions may be transmitted from a website, computer, server or data center to another website, computer, server or data center via a wired manner (such as coaxial cable, optical fiber, or digital subscriber line (DSL)) or a wireless manner (such as infrared, wireless or microwave). The non-transitory computer-readable storage medium may be any available medium able to be accessed by the computer, or may be a data storage device, such as a server or a data center, integrated by one or more available media. The available medium may be a magnetic medium (e.g., a floppy disk, a hard disk or a magnetic tape), an optical medium (e.g., a DVD), a semiconductor medium (e.g., a solid state drive (SSD)), or the like.

It should be understood that in the various embodiments of the present application, the magnitude of the serial number of each of the above-mentioned processes does not mean the order of execution. The order of execution of each process shall be determined by its function and internal logic, and shall not constitute any limitation on the implementation process of the embodiments of the present application.

Those skilled in the art can clearly understand that for the convenience and simplicity of description, the working processes of the systems, devices and modules described above may refer to the corresponding processes in the above method embodiments, and details will not be repeated here.

The foregoing descriptions are merely exemplary implementations of the present application, but the protection scope of the present application is not limited thereto. Any skilled person in the art could readily conceive of changes or replacements within the technical scope of the present application, which shall all be included in the protection scope of the present application. Therefore, the protection scope of the present application shall be subject to the protection scope of the claims.

What is claimed is:

1. An information protection method, comprising:
performing, by a first device, security protection on first information by using a first key; and
sending, by the first device, the first information with the security protection to a second device, for use by the second device to send the first information with the security protection to a third device.

2. The method of claim 1, wherein the security protection comprises integrity protection and/or encryption.

3. The method of claim 1, wherein
performing, by the first device, the security protection on the first information by using the first key, comprises:
processing, by the first device, the first information by using the first key, to obtain verification information; and
sending, by the first device, the first information with the security protection, comprises:
sending, by the first device, the first information and the verification information.

4. The method of claim 1, wherein
performing, by the first device, the security protection on the first information by using the first key, comprises:
performing, by the first device, encryption on the first information by using the first key, to obtain encrypted first information; and
sending, by the first device, the first information with the security protection, comprises:
sending, by the first device, the encrypted first information.

5. The method of claim 1, further comprising:
generating, by the first device, the first key using a second key.

6. The method of claim 5, wherein generating, by the first device, the first key using the second key, comprises:
generating, by the first device, the first key using the second key before performing the security protection on first information; and/or
generating, by the first device, the first key using the second key according to a predetermined period.

7. The method of claim 1, further comprising:
sending, by the first device, a key identifier of the first key to the second device.

8. The method of claim 7, wherein
the key identifier of the first key being comprised in the first information; or the key identifier of the first key being independent of the first information.

9. The method of claim 1, wherein the first device comprises a terminal device, and the third device comprises a network device.

10. The method of claim 9, wherein the first information comprises user consent information.

11. The method of claim 9, further comprising:
receiving, by the terminal device, an authentication request message; and
generating, by the terminal device, the first key and/or a second key using parameters carried in the authentication request message, the second key being used to generate the first key.

12. The method of claim 11, wherein generating, by the terminal device, the first key and/or the second key using the parameters carried in the authentication request message, comprises:
generating, by the terminal device, a third key using the parameters carried in the authentication request message; and
generating, by the terminal device, the first key and/or the second key using the third key and other parameters and adopting a key derivation function (KDF).

13. The method of claim 12, wherein the third key comprises at least one of Kausf, Kakma, Kseaf, or Kamf.

14. The method of claim 12, wherein the other parameters comprise at least one of a user equipment (UE) identifier (ID), a random digit (RAND), a counter value, an uplink direction flag, or a downlink direction flag.

15. The method of claim 11, wherein the authentication request message carries a key identifier of the first key.

16. The method of claim 1, wherein the first device comprises a network device, and the third device comprises a terminal device.

17. The method of claim 16, further comprising:
obtaining, by the network device, the first key from a storage network element.

18. The method of claim 17, wherein obtaining, by the network device, the first key from the storage network element, comprises:
obtaining, by the network device, the first key from the storage network element before performing the security protection on the first information; and/or
obtaining, by the network device, the first key from the storage network element according to a predetermined period.

19. A communication device, comprising: a processor and a memory, wherein the memory is configured to store a computer program, and the processor is configured to invoke and execute the computer program stored in the memory to causes the communication device to perform:
performing security protection on first information by using a first key; and
sending the first information with the security protection to a second device, for use by the second device to send the first information with the security protection to a third device.

20. A communication device, comprising: a processor and a memory, wherein the memory is configured to store a computer program, and the processor is configured to invoke and execute the computer program stored in the memory to causes the communication device to perform:
receiving first information with the security protection from a second device, the first information with the security protection being received from the first device and forwarded by the second device; and
performing integrity verification and/or decryption on the first information with the security protection using a first key.
